(19) United States
(12) Patent Application Publication
(10) Pub. No.: US 2023/0095438 A1
(43) Pub. Date: Mar. 30, 2023

(54) AUTOMOTIVE HYDRAULIC SYSTEM SMART MONITOR AND SAFETY SYSTEMS AND DEVICES

(71) Applicant: Curtis Randolph, Pacoima, CA (US)

(72) Inventor: Curtis Randolph, Pacoima, CA (US)

(21) Appl. No.: 17/490,007

(22) Filed: Sep. 30, 2021

(51) Int. Cl. F15B 19/00; F15B 20/00

(52) U.S. Cl. CPC F15B 19/005; F15B 20/002; F15B 2211/6343; F15B 2211/6333

(57) ABSTRACT

Systems, devices, and methods are included for automotive hydraulic system smart safety switches that cut power to hydraulic motors when faults are detected using sensors, timers, and probes.

### TECHNICAL FIELD

The present disclosure generally relates to systems, devices, and methods of manufacturing automotive hydraulic system safety switches.

### BACKGROUND

Automobiles and other modes of transportation are often customized for any number of reasons, ranging from aesthetics to the types of work they may be tasked to perform. One type of customized automobile that has become popular is called a lowrider, which is an automobile that has been modified or manufactured to have its body ride very low over the ground, hence the name lowrider. Popular modifications to change an automobile from a standard model to a lowrider include the inclusion of hydraulic lift kits, which use a system of electronics and hydraulics to allow the owner or driver to modify the height at which the auto sits over the ground when being driven or parked.

Hydraulic lift kits typically include a number of different components that, when assembled, operate to lift and lower an automobile to a desired level, tilt the car sideways or front or back, and even bounce or hold wheels off the ground. Hydraulic lift kit components generally include pumps, dumps, fittings, hoses, cylinders, switches, batteries, and solenoids. As those in the art will understand, pumps operate to push fluid out to the cylinders and pump heads inside the pump are responsible for causing fluid movement. Dumps are valves that control hydraulic fluid in the system and are responsible for directing the pressurized fluid into the cylinders to lift or lower the vehicle. Fittings ensure all the parts are operably connected and help ensure safety, security, and efficiency. Hoses carry fluid from the pump to the cylinders. Cylinders are operable to extend and thereby lift the vehicle when filled with pressured fluid. The size of a cylinder determines how much lifting distance the vehicle may achieve. Cylinder sizes range from about four to sixteen inches, but can even range into sizes of several feet for owners who are particularly interested in jumping cars. Switches can provide power to pumps, which allows the entire hydraulic kit to turn on and can also control the movement of the car. Batteries provide power to pumps. In general, the more batteries that are operably connected, the faster the lifting operation can be achieved. Solenoids are responsible for switching power from the batteries to the pump and function as a heavy-duty relay to deliver power.

As with many electrically powered systems, problems may occur as the result of wiring or contact issues, heat dissipation, and/or other components and factors. As such, dangerous situations may exist or evolve and can result in sparks and/or fires, leading to expensive repairs, loss of use, and even injuries for an owner.

While lowrider vehicles have been popular in certain automobile enthusiast communities for more than half of a century, the industry is still largely filled with hobbyists who may or may not be experts in electrical wiring, welding, or other pertinent skills. This can lead to unintentional faulty wiring and other problems due to poor or inexperienced workmanship. Even skilled and highly knowledgeable hobbyists can be plagued by problems caused by subpar components.

For the foregoing reasons, a need exists for systems and devices that can quickly and effectively measure operating conditions for automotive hydraulic systems that automatically cut power to prevent catastrophic failures that may cause dangerous conditions.

### SUMMARY

In various embodiments, systems, devices, and methods for real-time automotive hydraulic safety monitoring and interruption are disclosed.

The devices, systems, and methods described herein generally are operably installed in an automobile lowrider hydraulic system and can be used to disable critical main power circuit grounding. These devices, systems, and methods include installation and operable electrical connection in a manner that allows them to measure and calculate one or more values and compare against a threshold and/or range to determine the existence of out of tolerance condition(s). One example of an out of tolerance condition can be caused by excessive motor use or on-cycle time, as may occur if solenoid contacts are improperly welded. In instances where out of tolerance conditions exist, the devices, systems, and methods described herein allow for nearly instantaneous safety measures to be enacted, namely, in the form of cutting power to one or more motors where a fault exists in order to prevent fire and/or other catastrophic failures.

The configuration of the systems and methods described herein in detail are only example embodiments and should not be considered limiting. Other systems, devices, methods, features, and advantages will be or will become apparent to one with skill in the art upon examination of the following figures and detailed description. It is intended that all such systems, devices, methods, features, and advantages be included within this description, be within the scope of the subject matter described herein, and be protected by the accompanying claims. In no way should the features of the example embodiments be construed as limiting the appended claims, absent express recitation of those features in the claims.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof. Moreover, all illustrations are intended to convey concepts, where relative sizes, shapes, and other detailed attributes may be illustrated schematically rather than literally or precisely.

### BRIEF DESCRIPTION OF THE DRAWINGS

The features and advantages of the present disclosure will be more fully described in, or rendered obvious by the following detailed description of the preferred embodiments, which are to be considered together with the accompanying drawings wherein like numbers refer to like parts and further, wherein:

FIG. 1A is a device diagram, in accordance with some embodiments described herein.

FIG. 1B shows a device diagram when the device is being tested, in accordance with some embodiments described herein;

FIG. 2 is a system architecture diagram, in accordance with some embodiments described herein; and

FIG. 3 is a process diagram, in accordance with some embodiments described herein.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Reference will now be made in detail to the present preferred embodiment(s), and examples of which is/are illustrated in the accompanying drawings. Whenever possible, the same reference numerals will be used throughout the drawings to refer to the same or like parts.

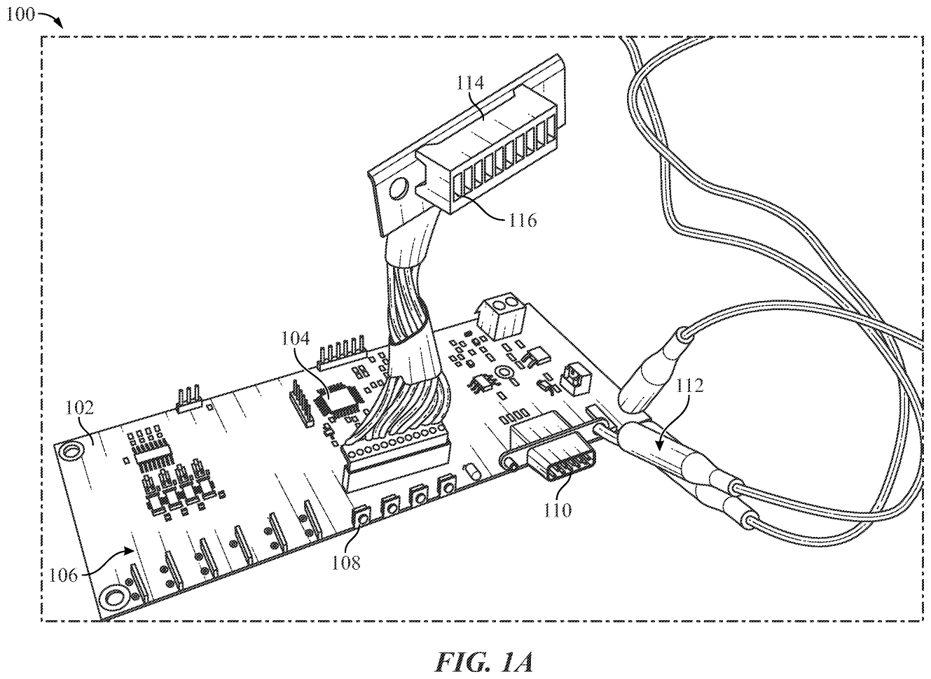

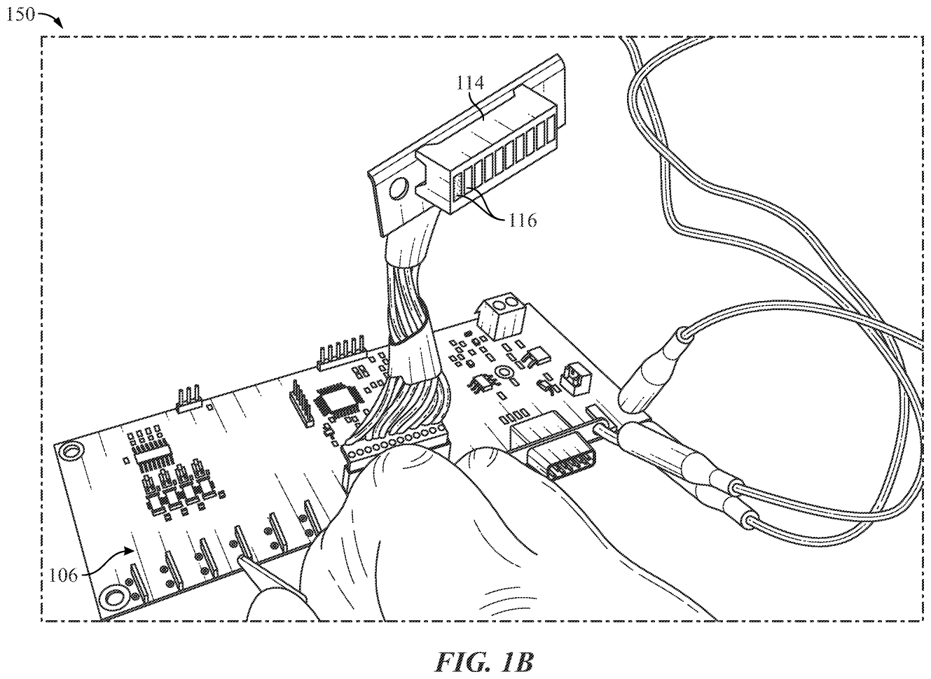

FIG. 1A is a device diagram 100, in accordance with some embodiments described herein. As shown in the example embodiment, a device can include a printed circuit board (PCB) 102. PCB 102 can include at least one processor and/or controller 104 that is operably electrically coupled with and/or includes at least one computer readable medium memory. Those in the art will understand that the steps and actions of the computer system described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art and operably coupled. An example storage medium may be coupled to the processor 104 such that the processor 104 can read information from, and write information to, the storage medium. In the alternative and as mentioned previously, the storage medium may be integrated into the processor 104. Further, in some embodiments, the processor and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

PCB 102 can also include at least one motor connection 106, whereby motors can be individually (or in some embodiments in groups) electronically controlled by the processor 104. At least one kill switch reset button 108 or component can allow users to reset the devices and systems herein to a default or primary status after a fault has been detected and/or triggered a switch. Also depicted are at least one I/O port 110 that can allow users to modify instructions stored in memory, access stored data such as event logs, and other functions, as appropriate. Further shown is/are power component(s) 112 for receiving and powering the unit and some or all of its components, as needed. While power component 112 in FIG. 1A is shown as leads, removable and or integrated battery power and other modes of powering are also contemplated in various embodiments. An LED array 114 can include one or more LEDs 116 that can indicate different statuses of the device. Additional components and coupleable devices include alarm features (e.g. audio transceivers, dedicated LEDs, and others), daughterboards with additional and/or complementary functionality, thermometers (e.g. explore device thermometers), current meter(s), pressure meter(s), smoke alarm(s), and others, as appropriate. Some or all of these components sensors can be coupled with the unit by serial interface, which in turn can perform power diagnostics and can display information to a user via a locally or remotely coupled visual display, which can be operable to display video in some embodiments.

In many embodiments, the devices and systems described herein can safely measure voltages from 24VDC to 132VDC. This allows the devices and systems to be highly versatile and operate in nearly any hydraulic system voltage configuration and/or environment that is currently common or likely to be used in the future.

One or more device probes and/or system probes (which are also referred to as sensors in this description) can be placed on, coupled with, or located substantially near a DC hydraulic motor power (input) terminal, as appropriate for the type of sensor or probe. In various embodiments these probes can be coupled to the devices and systems herein using wireless, wired, or a combination of both wireless and wired couplings. Wireless couplings will require wireless transceivers at the probe and the device, as are understood in the art and operably coupled and powered. These probes can also be operably coupled with or otherwise include a thermometer, current meter, smoke alarm, light sensor, and others in various embodiments. Device and/or system and probe combinations and couplings can be used to monitor and log real time conditions at, in, and/or near the associated motor and data can be stored in non-transitory computer readable media that can be used to calculate nominal preset values for safe overall system operation as normal operating conditions for a particular hydraulic setup and arrangement of batteries, motors, pumps, and the like. In various embodiments, the devices and systems described herein are operable to probe and poll each hydraulic motor independently for characteristics such as heat, current, and voltage or other pertinent information. Once measured, these values can be relayed or otherwise sent to the main PCB board for diagnostics operations, comparison and computation processes, and others.

Operators and/or users can apply or otherwise use a selection of one or more varied preset value ranges for different hydraulic system operations and monitoring functions. These preset ranges for heat and/or motor “on” time can be related to and understood as signifying particular operating conditions. Some values and/or ranges over particular amounts of time can indicate thermal runaway conditions in a motor that is affiliated with a sensor or probe that is providing data outside normal values and/or ranges. In instances where one or more of amperage, voltage, and temperature (heat) are rising over a baseline, threshold, and/or standard operating condition, these values may be indicative of or otherwise representative of an improperly fused electrical contact. After a calculated time lapse period has been exceeded (e.g. by measuring or indicating a value for a length of time exceeding a time threshold) from a set of selected pre-programmed values, the system processor can issue a signal in response that has particular significance in the system. In many instances this can be an all stop signal to a disengage port. Such signal will cause the port and/or components coupled to the port to disengage and thereby prevent any damage or additional damage from occurring to the affiliated motor and/or components or devices located in close proximity. To briefly elaborate, in various embodiments a disengage port can be an analog signal output to an alarm. It can also be a voltage signal used to feed a relay to engage or disengage a transistor that may in turn be galvanically isolated in order to break the circuit.

Devices and systems in the embodiments described herein can include one or more switch(es) (e.g. an up/down or on/off switch) to set one or more predetermined, preset trip times for each individual motor in the automobile hydraulic system. An off event can be utilized to set polling for motor voltages in order to perform fail condition analysis.

In some embodiments, the devices and systems herein can be used to determine and analyze smoke levels in a given environment (e.g. in the trunk area of an automobile where batteries, hydraulics, and/or motors may be housed or otherwise located) using smoke sensors or probes. In such instances, standard and/or special values can be set by a user within particular ranges of preset high and/or medium and/or low smoke sensitivity. If smoke is detected by an operably connected smoke sensor, a command can be issued by the processor instructing a fail-safe to engage. This in turn can disengage the problematic component in the location of the sensed smoke from the overall hydraulic system.

In various embodiments once the system has been tripped, engaged, and/or a component has been turned off due to measured conditions and their comparison with threshold values or ranges, part or all of the system may require a reset. In some instances, a reset can be a “hard” reset that is reserved on a microcontroller unit to clear registers that have issued the corresponding faults.

In some embodiments, a “black box” feature can be employed. In such instances, event data from the system can be logged and stored in non-transitory computer readable media for contemporaneous or later system analysis via a menu display (e.g. via an operably coupled user interface) and/or such data can be downloaded by direct download (wired or wirelessly via appropriate components) for use in another related and appropriate computing environment.

Some embodiments contemplated include test mode operations that allow users or operators to verify operation of various device and/or system features to enable users to verify system integrity. As an example of test mode functionality, a user may want to simulate conditions for four motors. In this instance, they could hold an “on” button or flip a switch to its “on” configuration for each motor up to a desired amount of time (e.g. see FIG. 1B, wherein a user is engaging a motor connection 106 of a board in a test environment that is not coupled to an actual motor. The system can then simulate a fault or other failure and break the connection between power and the switch (as shown in FIG. 1B, an LED 116 in array 114 can indicate which connection the fault is being measured from). This can be set to occur without additional operation the moment the switch on event is initiated. In a similar manner, a smoke detector test button can be pressed or otherwise engaged to initiate a shutdown condition in a testing phase. FIG. 1B shows a device diagram 150 when the device is being tested, in accordance with some embodiments described herein.

In various embodiments, a system printed circuit board schematic layout and electronic circuitry can been carefully designed and selected in order to incorporate and utilize components with the highest safety, effectiveness, and reliability. These can function to effectively augment safety features of other components, such as a Switch-Teck 504 lineup.

In various embodiments, visual indicators can be included to provide users with easy to recognize visual indications of system status. In some embodiments these can include one or more light emitting diode(s) (LEDs) (e.g. LEDs 116 of LED array 114 in FIGS. 1A-1B). In many embodiments, system disable switch(es) are included and dual color LEDs can indicate that a system is enabled with a color (e.g. green) or disabled with a color (e.g. red).

Various embodiments can include an override switch. This override switch can allow a user to override one or more functions of the system when engaged. A system reset button can also be included in various embodiments. System reset buttons (e.g. buttons 108 in FIG. 1A) can be used to return the system to an initial settings configuration, which can be useful after testing, after a fault has been triggered and/or fixed, or at other times and with other conditions.

As will be understood by those in the art, systems and devices according to the embodiments herein can utilize features that may be common to other boards, such as the Battle Switch board. Cloning the switch and LED features for ease of use is contemplated. Standalone switch boards can be produced that include a predetermined number of switches. For example, four switches can be used for applications with four motors. Alternate setups are also contemplated, for example, one switch might be used for two motors and another switch for another two motors in some embodiments.

Volatile markets can lead to shortages, delays, and other unpredictability in sourcing electronic components. As such, it can be highly beneficial to simplify designs when needed so that readily available components may be used when highly customized setups are scarce. As such, quantifying purchases can strengthen product longevity. Secondary features using LED diode bargraphs, standard 10 scale versions, and combinations thereof can be used in various embodiments. Jumper type piggyback boards can also add features and versatility to design strategies.

In some embodiments a kill operation can be performed or accomplished using a closed mechanical contactor that has a default closed position. Devices and systems can be designed to augment this/these component(s) into their design. Implementing one or more relay circuits can invert the default open signal to default closed. The board can also be enhanced by including one or more single input and output for preexisting kill contactor(s). This output can be substituted for a ground of a kill circuit and can be located physically at or near the device or system board in various embodiments.

In various embodiments the devices and systems described herein can include one or more input/output (I/O) port(s) (e.g. port 110 in FIG. 1A) that can be fed or otherwise receive or acquire data from a compatible device. In some instances a Switch-Teck 504 can have data germane to device and system operation. Data can include an event where an operator turned on or otherwise engaged the switch and an event where an operator released or otherwise disengaged the switch. Having On/Off data sent to the device can truncate response time for invoking kill operations in the event of a fault and/or failure. When connected to a daughter board, in some cases a Switch-Teck 504, the device can carry out extended functions. Devices and systems can include the ability to override operator settings and may be programmed to react with almost instantaneous response times when calculating solenoid failure conditions. When used as an I/O data stream, this information can be used for other enhanced features as well.

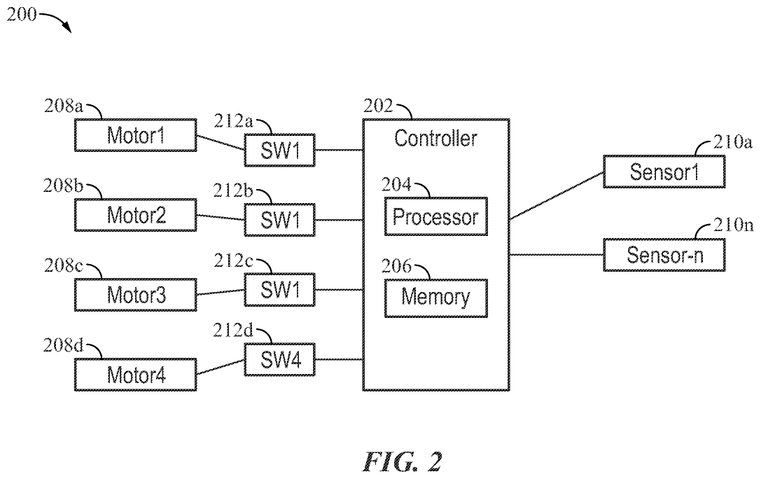

FIG. 2 is a system architecture diagram 200, in accordance with some embodiments described herein. As shown in the example embodiment, a system architecture can include a controller 202 (e.g. manufactured or customized PCB). Such controller includes components including at least one processor 204, memory 206 (e.g. non-transitory computer readable media), and can include additional components and/or connections for components such as user display(s), user interface(s) (e.g. keyboard, keypad, mouse, touchscreen, button(s)), audio component(s) (e.g. speaker(s), microphone(s), and/or other transceiver(s)), indicators (e.g. LED lights and others), power components, camera and/or video component(s), networking component(s), operating system(s), and/or other component(s), module(s), and attachment(s) as appropriate and connected/coupled to be functional and operable for the purposes described herein as understood by those skilled in the art and that are communicatively coupled to a wired and/or wireless network (e.g. the Internet). Such controller 202 can receive, store, and transmit information, display information via indicators and otherwise and receive inputs from users, and in some embodiments interact with other computing devices via a wireless and/or wired network.

In various embodiments, processor(s) 204 suitable for the execution of a computer program include both general and special purpose microprocessors and any one or more processors of any digital computing device. The processor 204 can receive instructions and data from a read-only memory or a random-access memory or both. The essential elements of a controller (also referred to herein as a computing device) are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices.

A network interface may be configured to allow data to be exchanged between the computing device and other devices attached to a network, such as other computing devices, sensors, or even between nodes of a computer system. In various embodiments, a network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory may include application instructions, configured to implement certain embodiments described herein, and a database, comprising various data accessible by the application instructions. In one embodiment, the application instructions may include software elements corresponding to one or more of the various embodiments described herein. For example, application instructions may be implemented in various embodiments using any desired programming language, scripting language, or combination of programming languages and/or scripting languages (e.g., C, C++, C #, JAVA®, .NET, SGC, JAVASCRIPT®, PERL®, etc.).

As shown in FIG. 2, one or more probes or sensors 210a through 210n can be coupled with the controller, which can be co-located, connected or coupled to, or located in proximity to motors 208a to 208d. Switches 212a through 212d can each be individually electrically coupled with each of motors 208a through 208d in order to cut power to the associated motor in the event that the information received from the associated sensor trips a fault.

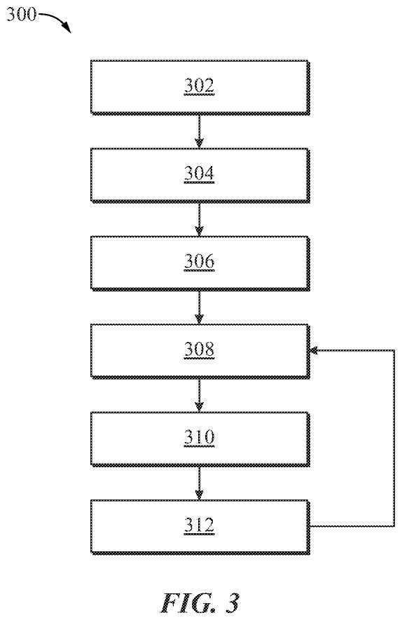

FIG. 3 is a process diagram 300, in accordance with some embodiments described herein. As shown in the example embodiment, steps can be combined in order to understand a general use process of the devices and systems disclosed herein. A first step 302 can include a user electronically coupling a controller device to the hydraulic system in an automobile. A second step 304 can include the user configuring default conditions (if not already set). A third step 306 can include a user testing the controller to ensure that it is properly operating (this step can also be repeated or moved to other locations in the process, including before the first step in order to ensure the controller itself is not faulty). A fourth step 308 can be a normal operating step, wherein the controller is operating under standard conditions. A fifth step 310 can optionally occur if the controller detects a fault in the system. In such case, the controller may trip a switch associated with the motor causing the fault and trigger an indicator such as an LED that a user can identify to further diagnose the problem. A sixth step 312 can include the user resetting the switch once the problem has been remedied and then returning to normal operating conditions (or optionally performing more testing on the controller).

16 Switch Parallel Configurations

| 1, 3 | 5, 7 | 5, 8 | 7, 6 | | |
|---|---|---|---|---|---|
| 2, 4 | 6, 8 | 6, 8 | 6, 8 | | |
| 1, 3, 5, 7 | | 1, 3, 6, 8 | | 1, 5 | 3, 7 |
| 2, 4, 6, 8 | | 2, 4, 5, 7 | | 2, 6 | 4, 8 |
| 1 | 3 | 5 | 7 | | |
| 2 | 4 | 6 | 8 | | |
| 1, 8 | 3, 6 | | | | |
| 2, 7 | 4, 5 | | | | |
| 1, 8 | 3, 6 | 4, 2 | 7, 4 | | |
| 2, 8 | 4, 6 | 6, 2 | 8, 4 | | |

In various embodiments the system can comprise one or more sensors, including flow rate, PSI/leak detection, fluid level (dipstick, oil level), ride height, hop measurement, smoke detection, voltage, and/or current sensors, among others. In at least some embodiments, the quantity of these sensors in a single vehicle system can be as follows: flow rate-2, PSI/leak detection-4, fluid level (dipstick, oil level)-4, ride height-4, hop measurement-2, smoke detection-1, voltage-24, and/or current sensors-4. Those in the art will understand where and how each of these sensors can be configured with respect to the conditions they monitor. For example, the flow rate sensors can be configured to monitor flow rate in the hydraulics, ride height sensors can be configured one to each wheel area to monitor leveling and orientation, voltage sensors can be configured for each battery, and so forth.

In various embodiments a power diagnostics board can monitor batteries when a user is operating the system, as well as when the system is idle or otherwise not in use and can calculate regeneration data. As desired, the system can or must measure the state of the batteries at time of current draw and issue a command in the form of a visual and/or audible alarm and/or output to the respective solenoid based on user set threshold(s), as well as transmit to a receiver the battery voltage, state of charge and or various data.

Power Diagnostics Module(s) can monitor up to and including eleven 12VDC Batteries or up to and including twenty-two batteries with a coupled auxiliary board when parallel battery arrays are used. The system is operable to monitor a variety of different battery technologies such as Absorbent Glass Mat (AGM) batteries, Lead Acid, and others that may each have different and unique operational thresholds and profiles for charge and discharge operations. Board functions and capabilities can include reading voltage, current or amperage, charge state, and may also calculate Amp-Hours (AH), resistance, capacity, charging amperage, time to full charge, time to full discharge, as well as Cold Cranking Amps (CCA) of each battery bank or array, along with total bank or array voltage parameters. Diagnostics Boards are capable of selecting one or more batteries with faults if the battery is not operating within battery array parameters. Parameter variable settings can be calculated and/or determined by dip switch settings or manufacturer or user programmed firmware. Information and data about current through and/or to and/or from the batteries as well as at nodes, voltages, charge states for each battery, internal resistance, and/or Cranking Amperes (which can indicate an estimation of a total for a battery bank) can be sent as an output to an LCD/LED or other display with a menu that is operable to display parameters. Bluetooth, WiFi, and/or other communications modules can communicatively couple the system to a user device and thereby provide data for review and use on a user interface, e.g. via an Apple app, Android app, proprietary app, or otherwise. System boards can be designed to implement storage card (e.g. SD or others) interface(s) to store device and/or equipment parameters via readable files (e.g. Excel or others). System boards can also be designed to read specific values and to display fault parameter information and designate the location(s) of fault(s) based on manufacturer and/or user defined thresholds, and also can be set with industry standard battery voltage values. System boards can be capable of equalization for a battery bank up to ten or twenty amperes. In some embodiments, equalization options may be restricted or otherwise only accessible through firmware program keys in an options menu, setting, or mode for auxiliary system board programming. Boards can monitor voltages ranging from 12VDC to 138VDC utilizing four-digit seven-segment voltage monitoring displays. In such embodiments, data can be transmitted to a piggyback or secondary LCD information display along with an optional or required LED bar graph to pinpoint a fault location battery in a bank or array. This feature can also be achieved through software and LCD display coding. A battery monitor can be BlueTooth or other communication standard capable with an ability to send and receive data or otherwise communicate with other modules, such as battery charger modules or apps stored on smartphones. Boards can feature auxiliary plugs to accommodate backup battery bank monitoring of the same sort that is commonly run parallel to the primary array. In practice, users are known to run two 60V battery arrays, thereby requiring the use of auxiliary boards and their features.

Auxiliary boards can typically receive up to and including eleven battery inputs that are assigned by users (e.g. dip switches) and work congruently with a main board and its software features.

Various upgradeable features are contemplated as follows.

1. A battery monitor upgrade can be graduated or increased by one. In practice what this means is that if an initial purchase includes four batteries as designated to be monitored, and if a user desires to monitor eight batteries at a later time, they can purchase a single four battery upgrade. Upgrade software modules are preferably downloadable via transceiver and/or transmitter and receiver and are stored in non-transitory computer readable memory to be recalled or otherwise accessed and run as new defaults. In some embodiments users may be required to register for a particular service in order to download related software, which can include a fee based portal and/or application that can be run on a smartphone or other mobile or stationary device. In some embodiments website or other system access can be provided to users who may have an upgrade period offered to them for a reduced cost or otherwise be offered a limited trial feature period. Serial authentication on a per unit basis and other verification methodologies can be used by system administrators in order to prevent users from unauthorized pirating of software modules.

2. Temperature Monitoring is a standard system upgrade. In some embodiments temperature monitors can handle up to twenty-four devices. However, different configurations are possible and users can customize their configuration based on whatever best suits their hydraulic installation needs, including their battery array(s). The basic operation of the temperature monitor is to read, set, store, and display any value recorded as well as threshold values.

3. System Analysis and Data Logging can be performed in order to determine system strength and weakness monitoring. Utilizing power diagnostics data in conjunction with temperature monitoring software data, the system can implement a Strengths and Weakness Protocol to evaluate and compare readings to pinpoint strengths and or weaknesses in the Hydraulic system configuration and detect which node, if any, is having an issue.

4. No risk feature for users can be applied in a fully unlocked version and during a trial period in some embodiments. The configuration of the system board can be programmable as to what features are standard and which are optional. If a user is granted access to a designated feature as a trial when purchased for a designated period, these features can be programmed and managed internally (or remotely in some instances) with a lockout date in the coding of an enable and disable of such feature(s).

5. Active Warning System, including a smoke alarm and/or warning features. The system board and/or daughter board(s) can be equipped with a smoke alarm that will inhibit or otherwise lockdown Hydraulic Systems operation and warn users of emergency situations via display outputs, which can be enabled to output to any preprogrammed device that is communicatively coupled with or otherwise has the monitoring software downloaded to it.

6. Data logging and Data monitoring analysis provides for all collected data to be downloadable via menu commands. In some embodiments Menu Information can include: 1) General System information such as revision and version, device serial number, system add-ons and setup information, including: event time stamped recording intervals, on all events, all devices, retain all events, retain past actions (with customization for quantity: all, last one event, last seven events, etc.). 2) Receiver setup data, such as revision and version, device serial number, default settings, programmed settings, programs in memory, add-ons, smoke detector, local relay board, charge relay, local switch configuration, remote switch option, P-brake enable, and/or kill relay, and others. 3) Transmitter Setup Data, such as revision and version, device serial number, and/or system add-ons including PWM, Memory/SDram, Universal-Remote, and/or BattleStick, and others. 4) Temperature Monitor Data, such as revision and version, device serial number, threshold values, device nodes, and/or alarm data, and others. 5) Battery Monitor Data, such as revision and version, device serial number, device(s) total ( ) system add-ons, piggyback/installed, battery configuration, voltage, capacity, amp draw, charge rate, and/or discharge, and others, event time stamp recording—enabled or disabled, log data—enabled or disabled, and/or number of records stored, and others. 6) System Strength and Weakness Data, such as data analysis version, composer ID, and/or date code, and others. 7) Master Display, such as saved settings for all systems, and/or display features, and others. General system information can include or contain data pertaining to the switch module(s). Software updates can include revisions and be directed to all installed components, as well as system settings for technical support.

Remote Actuation Board information: The Transmitter/Receiver. System controller can be any appropriate controller, including a Switch Teck-504 controller, that uses smart monitoring features such as event monitoring, data logging, recording, and storing of hydraulic system operation data as it pertains to safe and prolonged operation of the hydraulic system. With this stored data the system can be operated in a manner that replicates or mimics a dance, hop or bounce move that was previously performed by the vehicle hydraulic system via a record and playback mode on switch button keypad or other user interface. Also the controller can output logged data to be uploaded to another controller system to perform like or similar functions.

System programming can be achieved or implemented via a computer interface and programming software using the stored dataset for various movements or hydraulic actuation sequences can be created, downloaded and/or uploaded for playback. An algorithm for safe hydraulic operation parameters can also be stored in memory on a computer, and can be coupled with a smartphone to allow users to upload datasets in order to evaluate potential strengths and weaknesses of the respective hydraulic system to further maximize proficient operation of the hydraulic system.

A 433 MHz receiver control board employing nonstable pulse-width modulation (PWM) control pulses can be used to actuate a 20A solid state relay at selectable pulse rate intervals ranging from 1/10 s (0.10 s) to 5/10 s (0.50 s) to control a board and employ nine channel functions with the ability to combine channel signal to work independently or as a two or four channel controller driving four or eight relays as a Single Pole Single Throw (SPST) switch or a Single Pole Double Throw (SPDT) switch. Many implementations are user friendly and preferably include analog knobs, one for each channel pulse rate from 0.01 s to 0.05 s, with a total of eight knobs having five pulse selections each. Four switches can be included to combine channels one and three, two and four, five and seven, and six and eight. Channel nine can be latched on when pressed and latched off when pressed again to enable an emergency disconnect.

In may embodiments a system board operational voltage can be 12VDC-24VDC. A receiver has the ability to “learn” from existing local or remote data in addition to being programmable via remote software download over a network or direct plugin.

Example of a Runtime scenario: Generally, there can be two hydraulic pump setups, three hydraulic pump setups, and four hydraulic pumps setups. These setups can employ a toggle switch to engage a solenoid that turn a communicatively coupled hydraulic pump motor on for an up or lift operation and actuates a dump pressure release valve for a down or lower motion in the hydraulic setup. A main system board feature can be its ability to accommodate a variety of setups.

The most common setups will typically be five channels, two pumps, and three dump actuators.

In some embodiments, channels are represented as follows: Channel 1 represents pump 1—up motion, Channel 2 represents actuator down motion, Channel 3 represents pump 2—up motion, Channel 4 represents actuator down motion, Channel 5 represents pump 3—up motion, Channel 6 represents actuator down motion, Channel 7 represents Pump 4—up motion, and Channel 8 represents actuator down motion.

Using a firmware menu interface, a user can enable or disable the use of Pulse Width Modulation (PWM) output to engage a manual momentary buttons jog function which can provide channel versatility for those needing more dumps (down outputs) than pumps (up outputs), or vice versa.

System boards can implement LCD technology to incorporate programming features facilitated by the push button(s) menus to select desired function. As such, upgraded features employing the use of a graphic display can allow a user to photograph his vehicle in calibrated positions that can be displayed with respect to the position of the vehicle in real time as a simulated automobile current position. These can be silhouette positions, which are calibrated to show the user the current position of the vehicle (e.g. back-end up and front-end down or back-end down and front-end up).

The module includes one or more startup features that are selectable, including hydraulic positions that are stored and can be loaded or recalled by resetting to origin points and by setting lower limits for origin set points to calibrate the silhouette. This can also be set as system limits that are in reference to playback of programs saved in non-transitory computer readable memory. Data can also be stored and sent to or accessed by an application or other program for three dimensional rendering.

The system board can include a dedicated channel for an All STOP emergency function output. This can be referred to as a “Kill” function. Menu options can incorporate a memory record program and play back sequence, as described previously. Furthermore, the board can be set to a “remember” mode. During remember mode, the board can monitor user input and store it in memory for later playback upon user selection. This recording and playback sequence can use menu buttons that use keys to record tasks and to prompts can be displayed and followed to enable a self-start operation by selecting appropriate menu buttons, whereby flashing LEDs or other indicator(s) on a remote can indicate or declare the operation of program record mode.

In a user playback mode, each start function can be in a down channel 2, 4, 6 as defined by the user in setup mode. This can ensures that during playback mode the positions start from an origin (e.g. zero) to prevent failure due to misalignment of actual and programming positions.

Various functions described herein can be implemented and integrated with smartphone applications, which may function in parallel to or in addition to a dedicated remote. It should be understood that such operable configuration will require Bluetooth or other networking technology. Further, a remote can be set to parallel latch channels to a particular button on a transmitter. A final or last channel can be an emergency stop latching-on or latch-off.

When a user wants to exit a program playback, stop option can be engaged by sending a long pulse by pressing a key to reset (in some embodiments this can be any key) for at least a certain amount of time. Alternatively or additionally, an emergency stop can be engaged.

As will be understood by those in the art, in some embodiments several subset boards can be engaged to implement the concepts described herein. In various embodiments these can include DB9 and/or DB15 breakout boards, with soldering and tab extender boards, DB15 switch extender boards, twelve pin connector boards, male to male DB9 and DB15 cables, separate “Battle-Stick” boards that may house additional components which incorporate lithium batteries and charging thereof, key fobs and add-on switches, and others.

Receivers and transmitters can have local switches that enable programming of PWM features and/or added features, as well as buttons on the transmitter. Four and/or eight channel 433 MHz transmitters, receiver, and/or transceivers can be deployed into add-on switch modules such as key fobs and remote hopping switches (i.e. Battle-Sticks).

8-Channel Transmitter/Receiver: An 8-channel module can be optionally coupled with the system and can be provided with a standalone remote that includes a selection button on the Switch-Teck transmitter to enable/disable aux switch feature.

4-Channel Transmitter/Receiver: A Battle Stick can be a microphone type switch that employs 1 momentary (on) off (on) toggle switch at its upper surface or mask. At its base, such switch can be positioned or oriented with a temporary or permanent latching on—until twisted and unlatched SPST switch. These correspond to channel 1 and channel 2 respectively, and together these consist of 3 channels, with the third channel of the transmitter being connected to a relay output of the kill switch feature on the remote.

In the overall process of implementation and assembly of the system, switch wiring latching combinations can be configured via one or more user navigable software menus.

A typical hydraulic vehicle lifting and manipulation system using four switches to control three pumps and three dumps incorporates a DPDT switch to enable and engage two pumps simultaneously and may require only one dump for the front end of the vehicle. This configuration with a DPDT switch can also be used in replacement of a more typical rear-end two pump two dump setup.

In some embodiments, a switch can be used to select PWM selections. It may be beneficial to further enhance menus to combine switch functions, where logical and useful, as if the switch is a DPDT from a SPST. The menu can create DPDT where a switch will be the DPDT 1, select first DPDT channel for switch 1 is Channel 1, select combined DPDT channel is Channel 3, Enter, Processing channel 1, 3 on switch 1, select second DPDT combination for switch 1, select first combined channel 2, select second combined DPDT channel 4, Enter, processing channel 2, 4 for switch 1.

A MASTER OPERATION DIAGNOSTICS BOARD can include a graphics display and a small, simple computer such as a Raspberry Pi.

Overview: Project boards and their displays should generally complement each other and have a display effect that is ergonomically feasible for placement under a existing automobile or other vehicle dashboards. Although some boards have features common to themselves, remote displays generally will need to have the ability to be tethered to the system by way of multi-conductor light gauge wire(s). In some embodiments this wire comprises a run of fifteen feet or less. This is similar to the manner in which automotive aftermarket gauges exist on the market today. Boards sufficient to implement the teachings herein can include LED indicators showing the power is on, indicator(s) for Emergency Stop(s) (flashing in some instances), smoke alarm indicator(s), USB communications port(s), battery array analyzer(s), smoke detector alarm(s), temperature monitor(s), user setup, user store, and user recalls, upload and download capability to a computer for all Switch-Teck or board data, a dashboard or system monitoring panel, add on component interfacing, LED indicator(s), one or more reset buttons, a power on indicator, at least one channel output indicator, at least one emergency output indicator, at least one smoke alarm indicator, battery array voltage indicator(s) (red, orange, green, or others), temperature measurement indicator(s) (green, orange, red, or others), USB interface(s) or other developed common protocols, instrument panel and/or graphic display(s), and others.

Temperature Monitoring: There are several devices within a lowrider hydraulic network that can benefit from and may require temperature monitoring using system boards, such as a Switch Teck-504. Pump motors are often the most critical component that require temperature monitoring, many of which have Class-F winding and a maximum temperature of 311 degrees Fahrenheit.

In some embodiments a cooling system and motor temperature monitoring enclosure can be included. This enclosure can have a total of nine fans. The fans are generally positioned to push and pull air around the circumference of the pump motors, where there are four on each side of the enclosure in order to accomplish efficient cooling. The enclosure can also include one fan placed in the front to achieve the ultimate temp reduction.

The cooling system may require a circuit board designed to receive nine two-pin fan plugs. Voltage of 24VDC preferably incorporates diode surge protection as well as a temperature monitoring LED (e.g. Green-Yellow-Red) or some sort of decade style LED system.

Fan controller(s) for solenoid cooling device can include an alarm for extreme temperature ranges to notify users/operator of potential failure(s). An emergency disconnect feature can allow the system monitoring a motor for power via current sensing for pulse on time. Thermistor array(s) can be used to monitor the temperature of each solenoid as a whole and/or monitor each solenoid temperature to pinpoint an origin of failure. Upon overheating or solenoid failure, failure data is recorded and stored in memory for recall by loading for further analysis. Thereafter, corrective measures can be implemented via computer to add user selected temperature ranges and or overrides (e.g. disable monitoring) menu. Fan connectors can be placed on ribbon connectors and/or LED connectors. Thermistor input can be adjacent to fan input connectors on the ribbon connector to produce a dual header board to attach all fans and thermistor inputs to a central location inside the monitored enclosure. In summary, one or more microcontroller(s) can be designated and dedicated to monitoring multiple temperature relay boards. The board(s) can individually drive up to a maximum of four sets of solenoid fans and/or thermistor disconnect alarms.

Development of an enclosure for the multiple fan controllers is preferably labeled as to identify each motor (i.e. S1, S2, S3, S4). In some embodiments, this configuration will be standard for the solenoid enclosure as well. A solenoid output port may comprise of parallel fan and thermistor outputs. Using coupled thermistors may allow for a requirement of only one lead unless a multiplexer scheme is employed. An 80 A relay drive may allow for all relative fans for the system to be connected via one output on each card installed; namely there are four (4) cards, each capable of driving up to nine fans. In some embodiments, a layout for an extender board for fan termination of 9 fans connected to a small circuit board on side A, while use of a side B can include placement of a single fan termination plug as well as thermistor input. This will standardize the controller input/output interface terminations. In some embodiments a thermistor array can be implemented to monitor the temperature of each solenoid as a whole, while in other embodiments each solenoid's temperature may be monitored individually in order to pinpoint an origin in case of failure. One important note is that extender boards can be used as standalone components if cooling is required in non-enclosed areas.

A Voltage Sensor Disconnect can be included to add an emergency disconnect feature in situations where the system is monitoring a motor for power via current sensing for pulse on time. If a time threshold is exceeded, a disconnect signal may be sent?

The monitoring board can include a port to interface with the Switch-Teck-504, which in turn sends signals regarding display indications to the monitoring display accessory.

A voltage sensor disconnect can be implemented to add an emergency disconnect feature where the system monitors a motor for power via current sensing for pulse on time. If a time threshold is exceeded then a disconnect signal can be sent. In some embodiments a thermistor array can monitor the temperature of each solenoid or to monitor each solenoid temperature to pinpoint a failure origin.

System Instrumentation Display: The system, including the Switch-Teck board that functions as instrumentation monitoring for hydraulic systems is installed in vehicles. In some embodiments, such monitoring can be customized and fabricated specifically for certain types of vehicles and/or layouts, such as for the Chevrolet Impala '63-'64. Examples will be provided for different implementations.

Switch-Teck 5500 Series Instrument Cluster: A variety of components can be necessary for monitoring various engine dynamics, along with operator awareness of critical monitoring of vital hydraulic components. The monitoring of these components will ensure enhanced safety through the importation of data that can be displayed ergonomically within the vehicles dash, so that users can view it at a glance. That allows operators improved response time to manage any critical threats to system functional operations. As an example, an Instrument Panel can incorporates standard required instrumentation as well as the following: real time remote monitoring with dashboard elements that display control voltage, front pump voltage and/or temperature, rear pump voltage and/or temperature, battery pack status, solenoid temperature for banks one through four, system charge amps, an LED bar graph system indicating good-, fair-, poor-, and fail-conditions, date stamp, and others.

A Battery Bank Monitor can include an array and a standalone monitor, amp monitoring and usage, critical amp hour (Ah) calculations, voltage monitoring and/or sum and node points, voltage drop monitor, discharge rate, battery temperature, and others.

A Hydraulic Motor Monitor can include a voltage monitor, inrush current, constant current, actuation cycle duration/time on/time off, flyback voltage/current, temperature, and others.

A Solenoid Monitor can include monitoring of voltage, current, temperature, node to node current, [solenoid to solenoid], and node to node temperature, and others.

A Hydraulic System Monitor can include flow rate ultrasonic metering, GPM logging, PSI logging, calculate hydraulic pump displacement threshold, diagnose low oil conduction/issue low oil alarm, monitor fluid temp/diagnose cavitation factor, realtime auto-ride-leveling, and others.

System Charging Status can include monitoring system charge rate, calculate percentage of charge, time need for full charge, and others.

Current vehicles have standard alternators that can be utilized by the Switch-Teck board technology to provide continuous rejuvenation of battery power to enable worry free enjoyment of the hydraulic system.

The type of hydraulic systems the current embodiments can be implemented with generally have multiple pumps and batteries whereby the Switch-Teck 5500 technology will, when enabled, create a data-log by polling various monitoring variables.

Although the system can be wirelessly implemented, instrument clusters can provide safe access to data while operating the vehicle without distractions other than those akin to its current operation. The module should have the capability to download logged data and status.

5500 SERIES INSTRUMENT CLUSTER—The Switch-Teck 5500 Series Instrument Cluster will monitor speed monitor, odometer, temp, oil, blinker, brake, high beam, fuel, turn signals, clock/date, check engine, tachometer, gear shift location, voltage/Amps, selectable background illumination color, and others.

Hydraulic System Monitor can include up to three levels of implementation: hardware, firmware, and/or software.

As described elsewhere herein, a number of different systems and variables can be monitored by the system. These can include pump temperature monitoring including PSI and GPM Displacement; battery monitoring including system / battery, and voltage, current, amp; smoke monitoring; system charging status including amp, capacity; solenoid temperature monitoring, and others. Extended Services can also be included on a per module basis or form that will enable downloadable data for analysis.

An integrated voltage delivery management system can ensure that a minimum or appropriate amount of voltage is provided to engage and disengage solenoid demand(s). The management system can include a user selectable voltage range of 12V or 18V from a 24V power source. This configuration boosts voltage and stabilizes voltages which are known to vary as batteries are discharged. The management system can shield solenoids from potential hazards which, if left unchecked, would otherwise lead to solenoid failure. The management system will also monitor voltage transients for solenoid failure and issue command(s) to a kill system. By utilizing the management system users will need one unit per pump.

A system disable feature can monitor power to each hydraulic pump and determine if a solenoid has met a failure condition. This can be accomplished by, for example, comparing a current time on against a threshold duration (e.g. five seconds). If the time on meets or exceeds the threshold then the disable feature can engage to prevent harm to the system. If the threshold has not yet been met, then the system can allow the pump to continue running. Current time on can be measured through active polling or by more passive means.

The device is smart and able to accurately reference what devices it is monitoring, which can be designated or achieved by a jumper or slide position switch. The jumper can enable multiple thermistor array monitoring so that if the desired monitoring device is coupled with a solenoid array of up to five (5) solenoids, then the thermistor values can be used to calculate an average and the system can display a bar graph output on a user interface along with a desired output threshold monitoring temperature. This threshold can be user selectable from a list of common value ranges. If a thermistor or array registers a value out of range or an overheat condition, the value can be stored for later recall to identify the condition for correction or replacement of the out of range component. This process can be employed for some or all other monitoring features. When the system is monitoring, a green LED display may vary from one to four LED's before a fan preset condition is met. The fan output signal can be turned on at a first yellow LED display. However, when the temperature increases such that a second red LED is displayed, the system should issue an audible alarm and log the condition of the thermistor(s) once the audible alarm condition is exceeded with the initiation of a fourth red LED displayed for a preset amount of time, e.g. one minute. Then the system can issue a kill system output function. This feature can be user selectable to disable the audible alarm and the kill feature. The Solenoid monitor has a feature to read the voltage at the output side to determine if the motor has been on for too long, which will trigger an output to the kill switch. This feature is not disabled by the user if the feature is not used elsewhere.

In various embodiments, the board's can be integrated to include one or more microprocessors (standalone units) and can monitor the temperature of various units within the hydraulic system as a whole. In some embodiments, the fan control, solenoid, and battery monitors can share a common user interface display. This can be LED's or other indicators and/or a video display. Emergency shut down or kill switches can also be included on a remote transmitter. This can allow the user to quickly and safely disconnect the ground without having to perform manual disconnects.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a” “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

I/We claim:

1. A power management system for hydraulic motors in an automobile, comprising:
a processor communicatively coupled to a non-transitory computer readable medium;
a timer; and
a switch,
wherein the processor monitors the timer and if the timer exceeds a predetermined value then the processor activates the switch to cut power to at least one hydraulic motor in the automobile.

2. The power management system for hydraulic motors in an automobile of claim 1, further comprising:
a sensor,
wherein the processor is communicatively coupled to the sensor and is operable to:
compare a measured value from the sensor with a threshold value stored in the computer readable medium, and
if the measured value exceeds the threshold value, to activate the switch to cut power to at least one hydraulic motor in the automobile.

3. The power management system for hydraulic motors in an automobile of claim 2, where the sensor further comprises: a smoke sensor.

3. The power management system for hydraulic motors in an automobile of claim 2, wherein the sensor further comprises: a temperature sensor.

4. The power management system for hydraulic motors in an automobile of claim 1, further comprising:
at least one indicator that power has been cut to at least one hydraulic motor in the automobile.

5. The power management system for hydraulic motors in an automobile of claim 4, wherein the at least one indicator further comprises:
an audio indicator.

6. The power management system for hydraulic motors in an automobile of claim 4, wherein the at least one indicator further comprises:
a visual indicator.

7. The power management system for hydraulic motors in an automobile of claim 6, wherein the visual indicator further comprises:
at least one LED.

8. The power management system for hydraulic motors in an automobile of claim 1, further comprising:
at least one indicator that a switch has been tripped.

9. A method for managing power for hydraulic motors in an automobile comprising:
electronically coupling a controller device to the hydraulic system in an automobile;
configuring default conditions of the controller;
detecting a fault in the system that is associated with the hydraulic motor; and
cutting power to the hydraulic motor.

10. The method of claim 9, further comprising:
determining the hydraulic motor had power cut by viewing a visual indicator; and
resetting a switch once the fault in the system has been remedied.

11. A power management device for hydraulic motors in an automobile, comprising:
a processor communicatively coupled to a non-transitory computer readable medium;
a timer; and
a switch,
wherein the processor monitors the timer and if the timer exceeds a predetermined value then the processor activates the switch to cut power to at least one hydraulic motor in the automobile.

12. The power management device for hydraulic motors in an automobile of claim 11, wherein the processor is communicatively coupled to a sensor and is operable to:
compare a measured value from the sensor with a threshold value stored in the computer readable medium, and
if the measured value exceeds the threshold value, to activate the switch to cut power to at least one hydraulic motor in the automobile.

13. The power management device for hydraulic motors in an automobile of claim 12, where the sensor further comprises: a smoke sensor.

14. The power management device for hydraulic motors in an automobile of claim 12, wherein the sensor further comprises: a temperature sensor.

15. The power management device for hydraulic motors in an automobile of claim 11, further comprising:
at least one indicator that power has been cut to at least one hydraulic motor in the automobile.

16. The power management device for hydraulic motors in an automobile of claim 15, wherein the at least one indicator further comprises:
an audio indicator.

17. The power management device for hydraulic motors in an automobile of claim 15, wherein the at least one indicator further comprises:
a visual indicator.

18. The power management device for hydraulic motors in an automobile of claim 17, wherein the visual indicator further comprises:
at least one LED.

19. The power management device for hydraulic motors in an automobile of claim 18, wherein the at least one LED further comprises:
at least two colors to indicate at least two conditions.

20. The power management device for hydraulic motors in an automobile of claim 11, further comprising:
at least one indicator that a switch has been tripped.
